(19) United States
(12) Patent Application Publication
(10) Pub. No.: US 2025/0355189 A1
(43) Pub. Date: Nov. 20, 2025

(54) MULTILAYER STRUCTURE FOR OPTICAL COUPLING AND FABRICATION METHOD THEREOF

(71) Applicant: Taiwan Semiconductor Manufacturing Company, Ltd., Hsin-Chu (TW)

(72) Inventors: Tai-Chun Huang, New Taipei City (TW); Stefan Rusu, Sunnyvale, CA (US); Lan-Chou Cho, Hsinchu City (TW)

(21) Appl. No.: 19/284,518

(22) Filed: Jul. 29, 2025

Related U.S. Application Data
(63) Continuation of application No. 18/771,771, filed on Jul. 12, 2024.
(60) Provisional application No. 63/566,035, filed on Mar. 15, 2024.

(51) Int. Cl. G02B 6/34; G02B 6/30

(52) U.S. Cl. CPC G02B 6/34; G02B 6/30

(57) ABSTRACT

An apparatus for optical coupling according to the present disclosure includes a semiconductor substrate, a reflective layer disposed on the semiconductor substrate, a lower grating layer above the reflective layer, the lower grating layer including a base layer and a lower grating coupler above the base layer, grating teeth of the lower grating coupler facing the semiconductor substrate, and an upper grating layer above the lower grating layer, the upper grating layer including an upper grating coupler and a coating layer above the upper grating coupler, grating teeth of the upper grating layer facing away from the semiconductor substrate.

### PRIORITY DATA

This is a continuation application of U.S. patent application Ser. No. 18/771,771, filed Jul. 12, 2024, which claims benefit of U.S. Provisional Patent Application No. 63/566,035, filed Mar. 15, 2024, each of which is incorporated herein by reference in its entirety.

### BACKGROUND

The semiconductor integrated circuit (IC) industry has experienced exponential growth. Technological advances in IC materials and design have produced generations of ICs where each generation has smaller and more complex circuits than the previous generation. In the course of IC evolution, functional density (i.e., the number of interconnected devices per chip area) has generally increased while geometry size (i.e., the smallest component (or line) that can be created using a fabrication process) has decreased. This scaling down process generally provides benefits by increasing production efficiency and lowering associated costs. Such scaling down has also increased the complexity of processing and manufacturing ICs.

For example, optical gratings have been used to enable communication between light sources and other components (e.g., photodetectors). Optical gratings can be used to redirect light from an optical fiber into an optical detector. Light coupled from one end of the optical gratings that has been traveling transversely through the optical gratings by reflecting off the inner surfaces at shallow angles may be redirected so that it strikes the inner surfaces at a sharper angle that is greater than the critical angle of incidence, thus allowing the redirected light to escape from the other end of the optical gratings. After escaping, the light may impinge upon the optical detector. The detected light may then be used for various purposes, such as to receive an encoded communications signal that was transmitted through the optical gratings. Unfortunately, this process, as well as a reverse process in which optical gratings are used to redirect light from an on-chip light source to an optical fiber, in the context of traditional single layer grating couplers, may exhibit poor coupling efficiency and limited bandwidth, with a large part of the redirected light not reaching the optical detector. Single layer grating couplers are also susceptible to interference and attenuation. Accordingly, there exists a need to develop an apparatus and system of efficient optical coupling using optical gratings other than single layer grating couplers.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1A illustrates a cross-sectional view of a fiber-to-chip system, according to some aspects of the present disclosure.

FIG. 1B illustrates a top view of a grating coupler implemented in the fiber-to-chip system in FIG. 1A, according to some aspects of the present disclosure.

FIGS. 2A, 2B, 2C, and 2D are cross-sectional views of a grating section in a grating coupler, according to various aspects of the present disclosure.

FIGS. 3A, 3B, and 3C illustrate top and cross-sectional views of a multilayer grating coupler in one embodiment, according to some aspects of the present disclosure.

FIGS. 4A and 4B illustrate top and cross-sectional views of a multilayer grating coupler in another embodiment, according to some aspects of the present disclosure.

FIGS. 5A, 5B, and 5C illustrate top and cross-sectional views of a multilayer grating coupler in yet another embodiment, according to some aspects of the present disclosure.

FIGS. 6A, 6B, 6C, 6D, and 6E illustrate embodiments of a waveguide portion of a multilayer grating coupler, according to some aspects of the present disclosure.

FIGS. 7A, 7B, 7C, 7D, and 7E illustrate alternative embodiments of a waveguide portion of a multilayer grating coupler, according to some aspects of the present disclosure.

FIG. 8 illustrates a flow chart of a method for fabricating a multilayer grating coupler, according to some aspects of the present disclosure.

FIGS. 9A, 9B, 9C, 9D, 9E, 9F, and 9G illustrate fragmentary cross-sectional views of a workpiece during a fabrication process according to the method of FIG. 8, according to some aspects of the present disclosure.

FIG. 10 illustrates a cross-sectional view of a multilayer grating coupler in an alternative embodiment, according to some aspects of the present disclosure.

FIGS. 11A and 11B illustrate perspective views of a fiber-to-chip coupling system, according to some aspects of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Further, when a number or a range of numbers is described with “about,” “approximate,” and the like, the term is intended to encompass numbers that are within a reasonable range considering variations that inherently arise during manufacturing as understood by one of ordinary skill in the art. For example, the number or range of numbers encompasses a reasonable range including the number described, such as within +/−10% of the number described, based on known manufacturing tolerances associated with manufacturing a feature having a characteristic associated with the number. For example, a material layer having a thickness of “about 5 nm” can encompass a dimension range from 4.25 nm to 5.75 nm where manufacturing tolerances associated with depositing the material layer are known to be +/−15% by one of ordinary skill in the art. When describing aspects of a transistor, source/drain region(s) may refer to a source or a drain, individually or collectively, dependent upon the context.

Optical communication between chips has been used in order to permit the rapid transfer of information from one device to another device. Optical grating couplers (or simply as grating couplers) are used to couple optical signals from inside of the semiconductor chip to an optical fiber extending between different devices, and vice versa. However, as the size of semiconductor chips continues to decrease, density of features increases. Traditional grating couplers based on a single layer structure have to shrink in dimensions, which may lead to poor coupling efficiency and limited bandwidth. Distance between adjacent grating couplers would have to decrease to fit in limited chip area, which may lead to increased interference and attenuation.

The present disclosure provides grating couplers based on a multilayer structure to improve coupling efficiency, bandwidth, and stability of the device. In a multilayer structure, each grating layer has its own grating topology, which can adjust the spacing and angle to guide the light waves to the optimal position and reduce energy loss. In addition, a multilayer structure may increase the distance between input and output ports to reduce interference and attenuation and thus improve stability. An exemplary grating coupler may include multiple grating layers vertically stacked. Each grating layer may have an optical waveguide formed therein with a different refractive index, which can guide the light signal in different directions. The grating layer is used to couple the light signal to the optical waveguide and may independently have different grating parameters (e.g., grating period, grating duty cycle, grating aspect ratio, etc.) and directions to achieve different coupling efficiencies. An exemplary multilayer grating coupler may utilize two different characteristics to superimpose two types of light energy, achieving wide bandwidth and low loss. The disclosed multilayer grating couplers have a high coupling efficiency, bandwidth, and stability of the light signal, as well as reliability and scalability of the device. Furthermore, the disclosed multilayer structure for grating is easy to implement in any suited silicon photonics input/output (I/O) and high-speed applications, as well as convenient for wafer-scale testing and low-cost packaging.

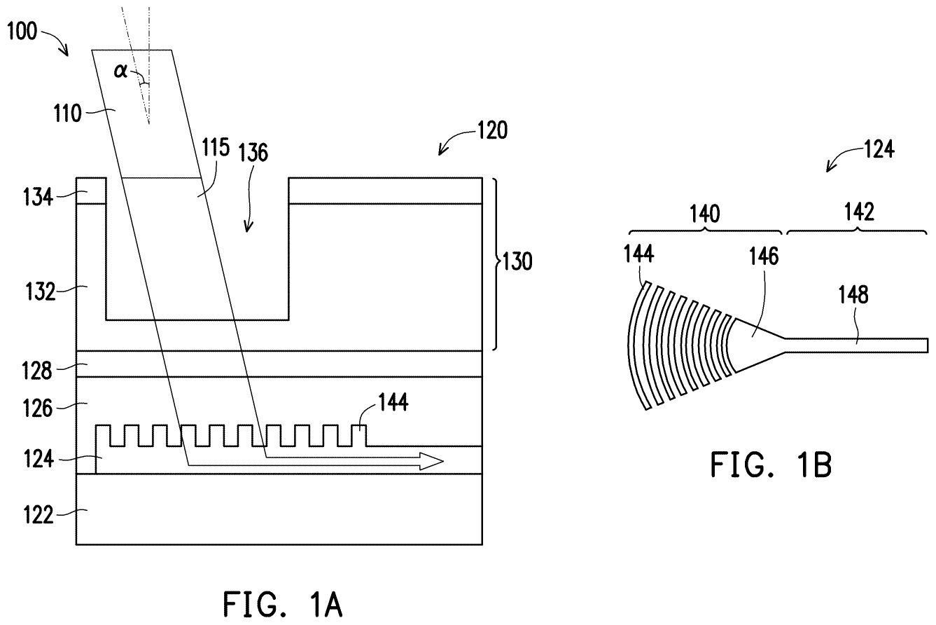

Reference is now made to FIGS. 1A and 1B, collectively. FIG. 1A is a cross-sectional view of a fiber-to-chip coupling system 100 in accordance with some embodiments. FIG. 1B is a top view of a grating coupler 124 implemented in the system 100. The system 100 includes an optical fiber 110 configured to emit an optical signal 115. The system 100 further includes a chip 120. The chip 120 includes a substrate 122. A grating coupler 124 is positioned above the substrate 122. A coating layer 126 covers the grating coupler 124. An etch stop layer 128 is disposed above the coating layer 126. An interconnect structure 130 is over the etch stop layer 128. The interconnect structure 130 includes an inter-metal dielectric (IMD) layer 132 and a conductive layer 134. FIG. 1A includes a single IMD layer 132 and conductive layer 134. However, one of ordinary skill in the art would recognize that the interconnect structure 130 may include multiple IMD layers and conductive layers in order to electrically connect different components of the chip 120. An opening 136 extends through a portion of the interconnect structure 130.

The grating coupler 124 includes a grating section 140 and a waveguide section 142. The grating section 140 includes grating features (also termed as grating teeth) 144 protruding upwardly from the grating coupler 124 and a tapering-shaped waveguide transition feature 146. In the depicted embodiment, each of the grating features 144 has an arc-shape. The grating section 140 is configured to receive and direct the optical signal 115 into the waveguide section 142 through the tapering-shaped waveguide transition feature 146. The waveguide section 142 includes a waveguide 148 that receives the optical signal 115 transmitted from the tapering-shaped waveguide transition feature 146 and relays the optical signal 115 to an optoelectronic component of the chip 120. One of ordinary skill in the art would recognize that additional layers, such as cladding and reflective layers, may be included in the system 100.

The optical fiber 110 may be a single-mode or multimode optical fiber. The optical fiber 110 is configured to convey the optical signal 115 from an external device to the chip 120. The optical fiber 110 may be positioned normal with respect to a top surface of the chip 120 (or the top surface of the grating coupler 124). Alternatively, the optical fiber 110 may deviate from the normal position by an angle a. The angle a may range up to 2-degrees, 5-degrees, or 10-degrees, depending on system requirements.

The optical signal 115 has a wavelength. In some embodiments where the optical fiber 110 is a single-mode fiber, the wavelength of the optical signal 115 may range from about 1260 nanometers (nm) to about 1360 nm. In some embodiments where the optical fiber 110 is a multimode optical fiber, the wavelength of the optical signal 115 may range from about 770 nm to about 910 nm. The wavelength of the optical signal 115 is based on a light source used to generate the optical signal. In some embodiments where the optical fiber 110 is a single-mode optical fiber, the light source may be a laser or a laser diode. In some embodiments where the optical fiber 110 is a multimode optical fiber, the light source of the optical fiber may be a light emitting diode (LED). The optical signal 115 may diverge upon exiting the optical fiber 110.

The chip 120 includes at least one optoelectronic component, such as a laser driver, digital control circuit, photodetectors, waveguides, small form-factor pluggable (SFP) transceiver, high-speed phase modulator (HSPM), calibration circuit, distributed Mach-Zehnder Interferometer (MZI), grating couplers, light sources, (i.e., laser), or the like. The optoelectronic component is configured to receive the optical signal 115 from the grating coupler 124 and convert the optical signal 115 into an electrical signal. While FIG. 1A depicts the chip 120 receiving the optical signal 115 from the optical fiber 110, one of ordinary skill in the art would understand that the system 100 is also usable to transfer an optical signal from the chip 120 to the optical fiber 110. That is, the optoelectronic component generates the optical signal, which is then transferred to the optical fiber 110 through the grating coupler 124, in some embodiments.

In some embodiments, the substrate 122 includes an elementary semiconductor including silicon or germanium in crystal, polycrystalline, or an amorphous structure; a compound semiconductor including silicon carbide, gallium arsenic, gallium phosphide, indium phosphide, indium arsenide, and indium antimonide; an alloy semiconductor including SiGe, GaAsP, AlInAs, AlGaAs, GaInAs, GaInP, and GaInAsP; any other suitable material; or combinations thereof. In some embodiments, the alloy semiconductor substrate has a gradient SiGe feature in which the Si and Ge composition change from one ratio at one location to another ratio at another location of the gradient SiGe feature. In some embodiments, the alloy SiGe is formed over a silicon substrate. In some embodiments, the substrate 122 is a strained SiGe substrate. In some embodiments, the semiconductor substrate has a semiconductor on insulator structure, such as a silicon on insulator (SOI) structure. In some embodiments, the semiconductor substrate includes a doped epi layer or a buried layer. In some embodiments, the compound semiconductor substrate has a multilayer structure, or the substrate includes a multilayer compound semiconductor structure.

The grating coupler 124 is configured to direct the optical signal 115 from the grating section 140 and the waveguide section 142 to an optoelectronic component of the chip 120. The grating coupler 124 includes an optical transparent material. In some embodiments, the grating coupler 124 includes silicon, silicon nitride, or other suitable optical transparent material. In some embodiments, the waveguide 148 includes a different material from the grating features 144. In some embodiments, the waveguide 148 is a slab waveguide, a planar waveguide or a light pipe. In order for the grating features 144 to effectively couple the optical signal 115 into the waveguide 148, the grating features 144 redirect the incident optical signal 115 into an angle of acceptance of the waveguide 148. The angle of acceptance of the waveguide 148 is based on the wavelength of the optical signal, the frequency of the optical signal and dimensions of the waveguide 148.

The coating layer 126 includes a dielectric material, such as silicon oxide (e.g., quartz, and/or glass). The etch stop layer 128 is over the coating layer 126 and has a different etch chemistry from the coating layer 126 and the IMD layer 132. In some embodiments, the etch stop layer 128 is deposited using chemical vapor deposition or another suitable deposition process. In some embodiments, the etch stop layer 128 includes silicon carbide, silicon nitride, aluminum oxide, or another suitable material.

The interconnect structure 130 is configured to electrically connect the optoelectronic component to other components within the chip 120 or to external devices, for example, through chip bonding. The IMD layer 132 includes a dielectric material. The IMD layer 132 provides electrical insulation between the conductive layer 134 and other conductive elements within the chip 120. The IMD layer 132 is deposited on the etch stop layer 128 using chemical vapor deposition, physical vapor deposition, or another suitable deposition process. In some embodiments, the IMD layer 132 includes a low-k dielectric material. In some embodiments, the IMD layer 132 includes the same material as the coating layer 126. In some embodiments, the IMD layer 132 includes a different material from the coating layer 126. The conductive layer 134 is configured to convey electrical signals to various components in the chip 120, for example the optoelectronic component. In some embodiments the conductive layer 134 includes copper, aluminum, tungsten, alloys thereof or another suitable conductive material.

The cavity 136 reduces an amount of material that the optical signal 115 passes through before being directed into the grating coupler 124. The cavity 136 extends through the conductive layer 134 and partially through the IMD layer 132. In some embodiments, the cavity 136 extends through an entirety of the interconnect structure 130 to expose the etch stop layer 128. The sidewalls of the cavity 136 are substantially vertical. In some embodiments, the sidewalls of the cavity 136 are tapered. In some embodiments, a width of the cavity ranges from about 10% to about 20% more than the width of the optical fiber 110. The extra width helps to account for misalignment between the optical fiber 110 and the cavity 136. The extra width also helps to permit the entire optical signal 115 to pass through the cavity 136 even though the optical signal 115 may diverge upon exiting from the optical fiber.

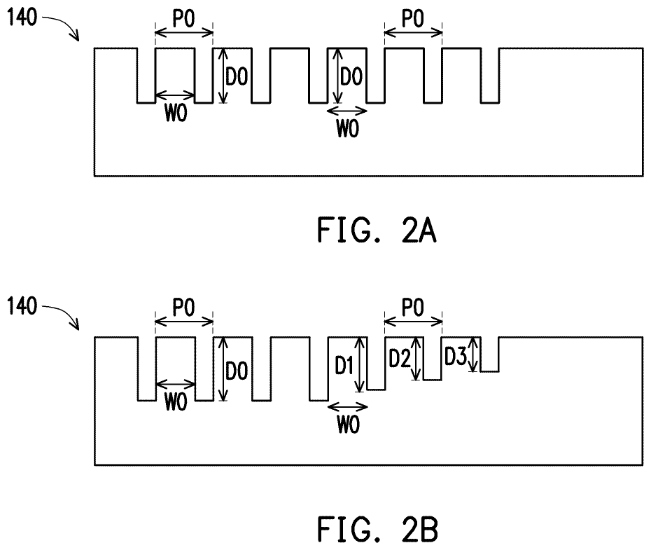

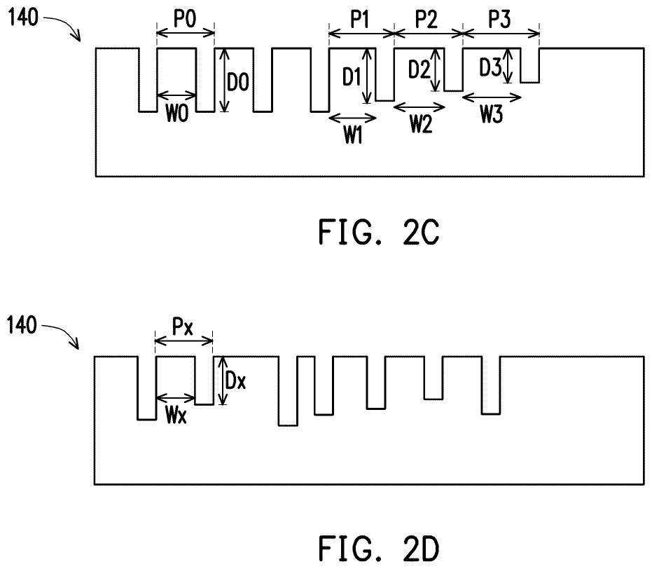

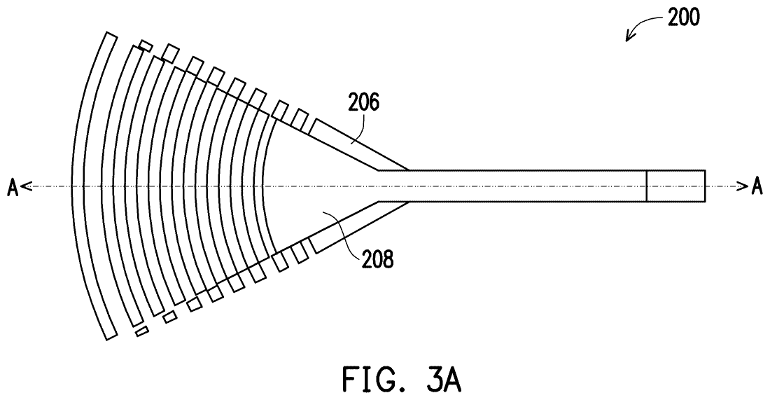

Reference is now made to FIGS. 2A-2D. FIGS. 2A-2D illustrate cross-sectional views of the grating section 140 in the grating coupler 124 according to various embodiments of the present disclosure. The grating coupler 124 in various illustrated embodiments differs in geometric dimensions of the grating features 144, in optimizing different design parameters, such as incident angle, coupling efficiency, bandwidth, or combinations thereof. In FIG. 2A, the grating section 140 includes grating features 144 having consistent geometric dimensions, such as width (also termed as duty cycle in the context of grating coupler) W₀, pitch P₀, and depth D₀. Accordingly, the trenches between adjacent the grating features 144 also have consistent geometric dimensions with a width defined by the difference between the pitch P₀ and the width W₀ (i.e., P₀−W₀) and a depth equals D₀.

In some embodiments, the grating section 140 may include a variable grating section besides a uniform grating section, which includes grating features having different geometric dimensions. The variable grating section may include grating features 144 having a variation in width, pitch, depth, or combinations thereof. For example, in FIG. 2B, the grating section 140 includes a uniform grating section with consistent geometric dimensions and a variable grating section with variable depths Dₓ (such as D₁, D₂, D₃, etc.). The uniform grating section and the variable grating section still have the same pitch P₀ and the width W₀. In FIG. 2C, the grating section 140 includes a uniform grating section with consistent geometric dimensions and a variable grating section with variable widths Wₓ (such as W₁, W₂, W₃, etc.) and accordingly variable pitches Pₓ (such as P₁, P₂, P₃, etc.). Including the variable grating section closer to the optoelectronic component than the uniform grating section helps the grating section 140 redirect the optical signal 115 at a less severe angle. For example, the grating section 140 may be able to redirect incident light at a less severe angle, such as 85-degrees other than 88-degrees, and still couple the optical signal 115 into a waveguide.

In FIGS. 2B and 2C, within the variable grating section, the geometric dimensions of the grating features 144 vary in a monotone gradient (e.g., from a larger depth to a smaller depth and/or from a smaller pitch to a larger pitch along the lengthwise direction). However, one of ordinary skill in the art would recognize that the geometric dimensions of the grating features 144 may be distributed more randomly without adhering to a monotone gradient, as shown in FIG. 2D, where the widths Wₓ, pitches Pₓ, and depths Dₓ, alone or in combinations, are more randomly distributed. Furthermore, the grating section 140 may include the variable grating section without having a uniform grating section. Various configurations of the geometric dimensions of the grating features 144 help achieve different design optimizations, such as a less severe angle, higher coupling efficiency, larger bandwidth, or combinations thereof.

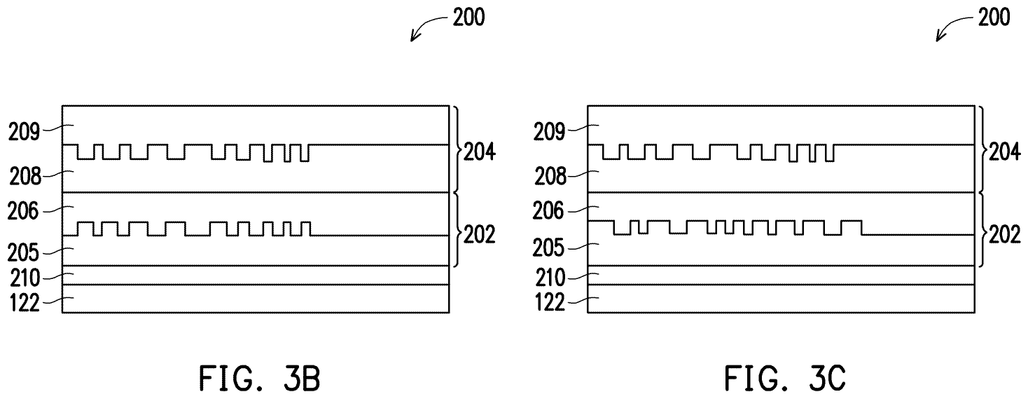

Reference is now made to FIGS. 3A-3C. FIG. 3A illustrates a top view of an exemplary multilayer grating coupler 200 that includes a lower grating layer 202 and an upper grating layer 204. The lower grating layer 202 includes a lower grating coupler 206, and the upper grating layer 204 includes an upper grating coupler 208. The lower grating coupler 206 and the upper grating coupler 208 are back-to-back disposed. That is, the grating features of the lower grating coupler 206 is facing downwards (facing the substrate 122 underneath), and the grating features of the upper grating coupler 208 is facing upwards (facing away from the substrate 122).

Each of the lower grating coupler 206 and upper grating coupler 208 may be independently implemented with geometric dimensions of the grating features as discussed above with respect to FIGS. 2A-2D. FIG. 3B illustrates a cross-sectional view of the multilayer grating coupler 200 along a cut through the A-A line in FIG. 3A according to one embodiment in which the geometric dimensions of the grating features in the lower grating coupler 206 and upper grating coupler 208 are identical. In FIG. 3B, the grating features and trenches between adjacent grating features in the lower grating coupler 206 and upper grating coupler 208 are aligned. FIG. 3C illustrates a cross-sectional view of the multilayer grating coupler 200 along a cut through the A-A line in FIG. 3A according to an alternative embodiment in which the geometric dimensions of the grating features in the lower grating coupler 206 and upper grating coupler 208 are different. In FIG. 3C, some or all of the grating features and trenches between adjacent grating features in the lower grating coupler 206 and upper grating coupler 208 are misaligned due to different geometric dimensions.

The multilayer grating coupler 200 is disposed over a reflective layer 210 that is deposited on the substrate 122. As discussed above, the substrate 122 may include an elementary semiconductor including silicon or germanium in crystal, polycrystalline, or an amorphous structure; a compound semiconductor including silicon carbide, gallium arsenic, gallium phosphide, indium phosphide, indium arsenide, and indium antimonide; an alloy semiconductor including SiGe, GaAsP, AlInAs, AlGaAs, GaInAs, GaInP, and GaInAsP; any other suitable material; or combinations thereof. The reflective layer 210 may be a metal layer, such as a copper layer or an aluminum layer. In one example, the substrate 122 is crystalline silicon and the reflective layer 210 is a plated aluminum layer.

The lower grating layer 202 includes a base layer 205 on which the lower grating coupler 206 is formed. In some embodiments, the base layer 205 includes a dielectric material, such as silicon oxide or other suitable dielectric material. The lower grating coupler 206 includes an optical transparent material. In some embodiments, the lower grating coupler 206 includes silicon, silicon nitride, or other suitable optical transparent material. The upper grating layer 204 includes a coating layer 209 above the upper grating coupler 208. In some embodiments, the base layer 205 includes a dielectric material, such as silicon oxide or other suitable dielectric material. In one example, the base layer 205 and the coating layer 209 include the same dielectric material, such as silicon oxide. In another example, the base layer 205 and the coating layer 209 include different dielectric materials. The upper grating coupler 208 includes an optical transparent material. In some embodiments, the upper grating coupler 208 includes silicon, silicon nitride, or other suitable optical transparent material. In one example, the lower grating coupler 206 and the upper grating coupler 208 include the same optical transparent material, such as silicon nitride, and there is no obvious boundary between the lower grating layer 202 and the upper grating layer 204. In another example, the lower grating coupler 206 and the upper grating coupler 208 include different optical transparent materials, such as one made of silicon and another made of silicon nitride, and there is a visible boundary between the lower grating layer 202 and the upper grating layer 204.

During operation, a portion of an incident light (e.g., the optical signal 115 in FIG. 1A) is redirected by the upper grating coupler 208 into the respective upper waveguide in the upper grating layer 204, and a remaining portion of the incident light travel through the upper grating layer 204. The reflective layer 210 reflects the remaining portion of the incident light into the lower grating layer 202 and redirected by the lower grating coupler 206 into the respective lower waveguide in the lower grating layer 202. The light guided into the upper and lower waveguides may merge into one of the waveguides, which will later be discussed in further details. By recollecting the remaining portion of the incident light, more percentage of the incident light will be collected. Thus, the coupling efficiency of the multilayer grating coupler is higher than the traditional grating couplers implemented in a single layer. Further, since the coupling efficiency is naturally higher in the multilayer configuration, the design of the grating couplers may be loosened to favor bandwidth more, which allows the multilayer grating coupler to have a wider bandwidth than the traditional grating couplers implemented in a single layer.

Since the geometric dimensions of the grating features in the lower grating coupler 206 and upper grating coupler 208 are independently implemented, a pitch of the grating features in the lower grating coupler 206 may be larger than a pitch in the upper grating coupler 208, and vice versa; a width of the grating features in the lower grating coupler 206 may be larger than a pitch in the upper grating coupler 208, and vice versa; and a depth of the grating features in the lower grating coupler 206 may be larger than a pitch in the upper grating coupler 208, and vice versa. The geometric dimensions of the grating features independently define the performance of the lower grating coupler 206 and upper grating coupler 208. In some embodiments, the lower grating coupler 206 and the upper grating coupler 208 are both based on a low-loss configuration. In some embodiments, the lower grating coupler 206 and the upper grating coupler 208 are both based on a wide-band configuration. In some embodiments, the lower grating coupler 206 is based on a wide-band configuration, and the upper grating coupler 208 is based on a low-loss configuration, and vice versa. That is, the lower grating coupler 206 may have a larger bandwidth than the upper grating coupler 208, and the upper grating coupler 208 may have a higher coupling efficiency than the lower grating coupler 206, and vice versa.

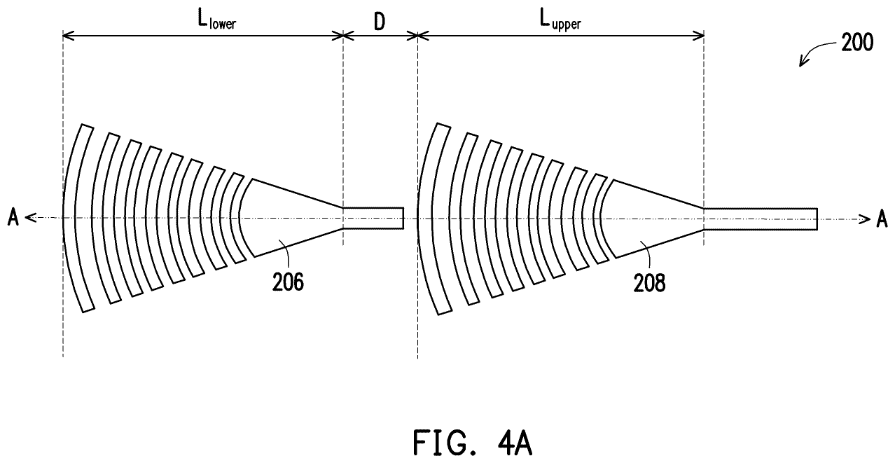

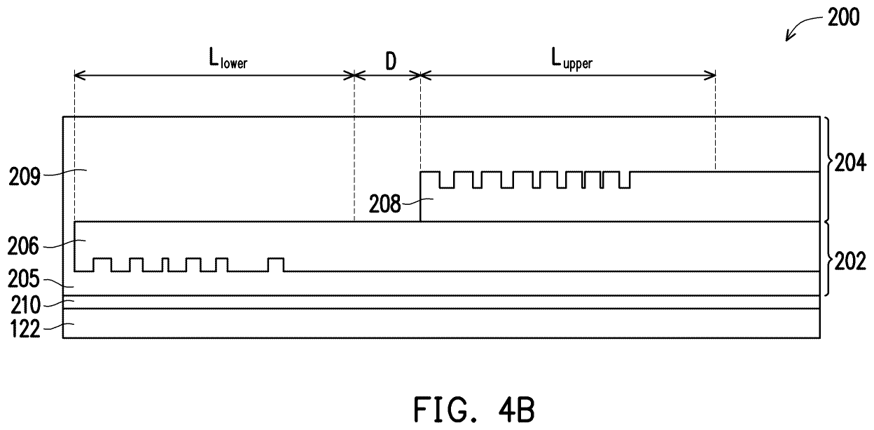

FIGS. 4A and 4B illustrate an alternative embodiment of a multilayer grating coupler 200, in which the grating sections of the lower grating coupler 206 and the upper grating coupler 208 are not overlapped but offset along the centerline of the grating couplers. FIG. 4A illustrates a top view of the multilayer grating coupler 200, and FIG. 4B illustrates a cross-sectional view of the multilayer grating coupler 200 along a cut through the A-A line in FIG. 4A. In the illustrated embodiment, the grating section of the lower grating coupler 206 has a length denoted as L_{lower}, which measures a distance from a tip (center point) of the first arc-shaped grating feature to an end point of the tapering-shaped waveguide transition feature. Similarly, the grating section of the upper grating coupler 208 has a length denoted as Lᵤₚₚₑᵣ. The lengths L_{lower} and Lᵤₚₚₑᵣ may be identical (i.e., L_{lower}=Lᵤₚₚₑᵣ) or different (i.e., L_{lower}<Lᵤₚₚₑᵣ or L_{lower}>Lᵤₚₚₑᵣ). In the illustrated embodiment, the two grating sections have no overlapping regions but offset by a distance denoted as D. In some embodiments, the separation D is not less than about 10% of the length Lᵤₚₚₑᵣ (e.g., 10%, 20%, 30%, 40%, 50%, or even larger). The range being not less than 10% is not trivial or arbitrary. If the range is smaller than about 10%, interference may become unneglectable and deteriorate device performance. Notably, the lower waveguide of the lower grating coupler 206 still travel underneath the grating section of the upper grating coupler 208 and overlap with the upper waveguide of the upper grating coupler 208 (not depicted in FIG. 4A for the sake of clarity, but in FIG. 4B).

Since the geometric dimensions of the grating features in the lower grating coupler 206 and upper grating coupler 208 are independently implemented, a pitch of the grating features in the lower grating coupler 206 may be larger than a pitch in the upper grating coupler 208, and vice versa; a width of the grating features in the lower grating coupler 206 may be larger than a pitch in the upper grating coupler 208, and vice versa; and a depth of the grating features in the lower grating coupler 206 may be larger than a pitch in the upper grating coupler 208, and vice versa. The geometric dimensions of the grating features independently define the performance of the lower grating coupler 206 and upper grating coupler 208. In some embodiments, the lower grating coupler 206 and the upper grating coupler 208 are both based on a low-loss configuration. In some embodiments, the lower grating coupler 206 and the upper grating coupler 208 are both based on a wide-band configuration. In some embodiments, the lower grating coupler 206 is based on a wide-band configuration, and the upper grating coupler 208 is based on a low-loss configuration, and vice versa. That is, the lower grating coupler 206 may have a larger bandwidth than the upper grating coupler 208, and the upper grating coupler 208 may have a higher coupling efficiency than the lower grating coupler 206, and vice versa.

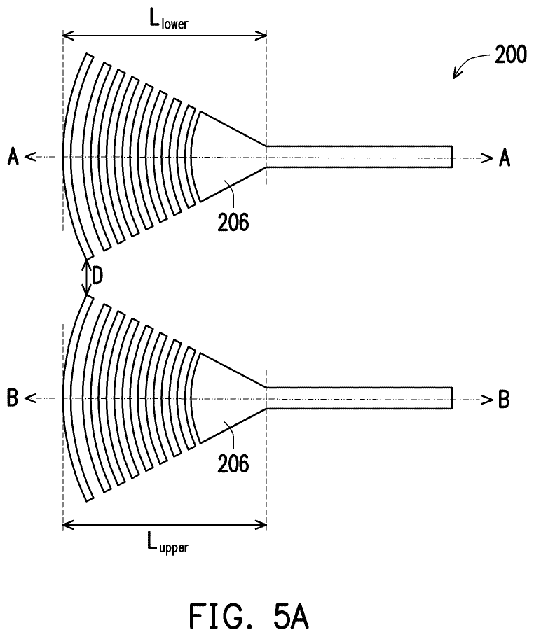

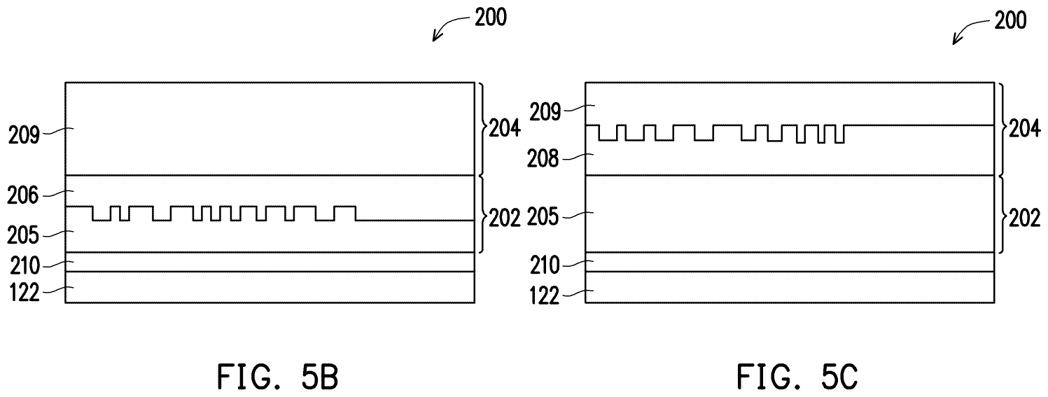

FIGS. 5A-5C illustrate an alternative embodiment of a multilayer grating coupler 200, in which the grating sections of the lower grating coupler 206 and the upper grating coupler 208 are not overlapped but offset in a direction perpendicular to the centerline of the grating couplers. FIG. 5A illustrates a top view of the multilayer grating coupler 200, FIG. 5B illustrates a cross-sectional view of the multilayer grating coupler 200 along a cut through the A-A line in FIG. 5A, and FIG. 5C illustrates a cross-sectional view of the multilayer grating coupler 200 along a cut through the B-B line in FIG. 5A. In the illustrated embodiment, the grating section of the lower grating coupler 206 has a length denoted as L_{lower}, which measures a distance from a tip (center point) of the first arc-shaped grating feature to an end point of the tapering-shaped waveguide transition feature. Similarly, the grating section of the upper grating coupler 208 has a length denoted as Lᵤₚₚₑᵣ. The lengths L_{lower} and Lᵤₚₚₑᵣ may be identical (i.e., L_{lower}=Lᵤₚₚₑᵣ) or different (i.e., L_{lower}<Lᵤₚₚₑᵣ or L_{lower}>Lᵤₚₚₑᵣ). In the illustrated embodiment, the two grating sections have no overlapping regions but offset by a distance denoted as D. In some embodiments, the separation D is not less than about 10% of the length Lᵤₚₚₑᵣ (e.g., 10%, 20%, 30%, 40%, 50%, or even larger). The range being not less than 10% is not trivial or arbitrary. If the range is smaller than about 10%, interference may become unneglectable and deteriorate device performance. Nonetheless, such a D is much smaller than a typical distance between two conventional grating couplers formed in a single layer without compromising the interference level. This is because having the upper and lower grating couplers in the depicted embodiment in two different layers effectively reduces the interference.

Since the geometric dimensions of the grating features in the lower grating coupler 206 and upper grating coupler 208 are independently implemented, a pitch of the grating features in the lower grating coupler 206 may be larger than a pitch in the upper grating coupler 208, and vice versa; a width of the grating features in the lower grating coupler 206 may be larger than a pitch in the upper grating coupler 208, and vice versa; and a depth of the grating features in the lower grating coupler 206 may be larger than a pitch in the upper grating coupler 208, and vice versa. The geometric dimensions of the grating features independently define the performance of the lower grating coupler 206 and upper grating coupler 208. In some embodiments, the lower grating coupler 206 and the upper grating coupler 208 are both based on a low-loss configuration. In some embodiments, the lower grating coupler 206 and the upper grating coupler 208 are both based on a wide-band configuration. In some embodiments, the lower grating coupler 206 is based on a wide-band configuration, and the upper grating coupler 208 is based on a low-loss configuration, and vice versa. That is, the lower grating coupler 206 may have a larger bandwidth than the upper grating coupler 208, and the upper grating coupler 208 may have a higher coupling efficiency than the lower grating coupler 206, and vice versa.

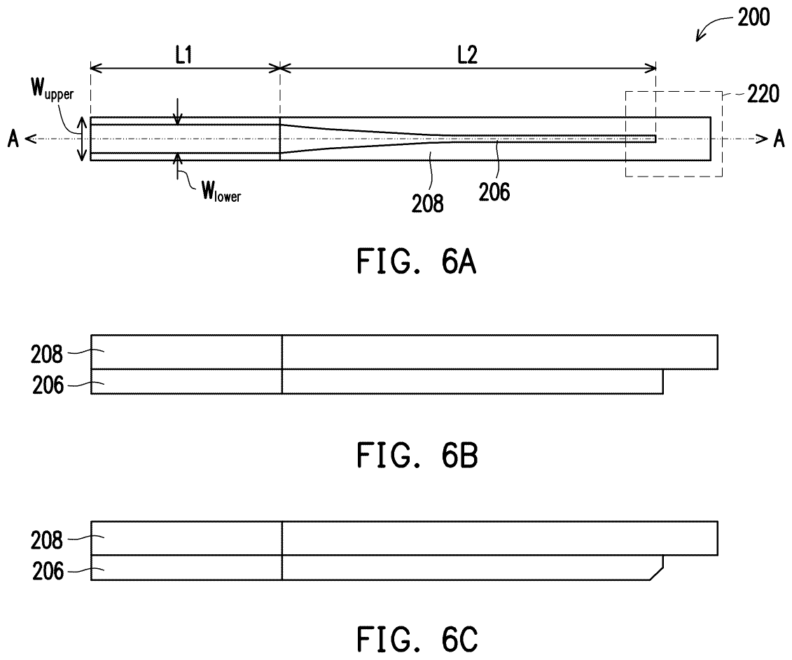

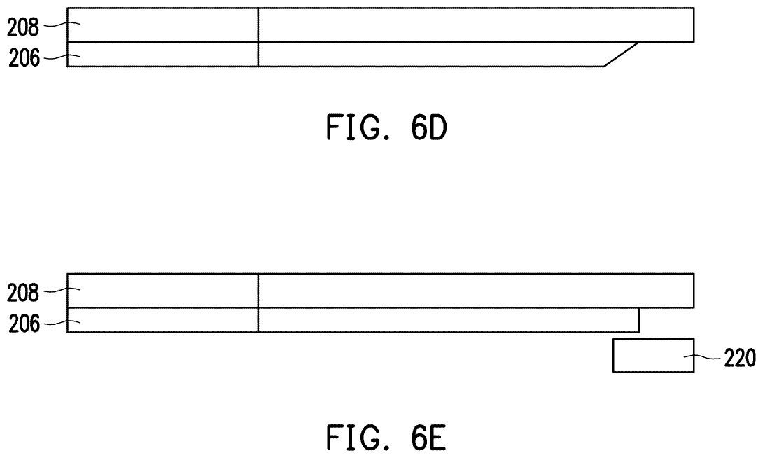

Reference is now made to FIGS. 6A-6E, which illustrate various embodiments of the waveguide portion of the multilayer grating coupler 200, particularly the portion merges light signals traveling in the upper and lower waveguides into the upper waveguide. FIG. 6A is a top view, and FIGS. 6B-6E are cross-sectional views along a cut though the A-A line in FIG. 6A according to various embodiments of the present disclosure.

Since the light signal merges into the upper waveguide in the depicted embodiment, the upper waveguide extends longer than the lower waveguide. The upper wave guide has a constant width Wᵤₚₚₑᵣ. The lower waveguide starts with a first section with a constant width W_{lower} for a length L₁ and gradually shrinks in its second section for a length L₂. The length L₁ may be equal to or less than the length L₂. With the shrinking of the second section, photons in the lower waveguide can be gradually guided toward the upper waveguide. The waveguide with a lower refractive index may be thicker and wider in width, while the waveguide with a higher refractive index may be thinner and narrower in width. In the depicted embodiment, the upper waveguide has a lower refractive index, and consequently the upper waveguide has the width Wᵤₚₚₑᵣ larger than the width W_{lower} of the first section of the lower waveguide, and also thicker. Although not depicted, if the upper waveguide has a higher refractive index, consequently the upper waveguide has the width Wᵤₚₚₑᵣ smaller than the width W_{lower} of the first section of the lower waveguide, and also thinner.

In FIG. 6B, the end of the lower waveguide has a vertical sidewall. As a comparison, in FIG. 6C, the end of the lower waveguide has a slanted sidewall and a vertical sidewall intersecting the upper waveguide, which reduces reflection at the terminal end. Similarly, in FIG. 6D, the end of the lower waveguide has a slanted sidewall intersecting the upper waveguide, which also reduces reflection at the terminal end. In addition, an optical absorbing material 220 may optionally be placed adjacent to the end of the lower waveguide as a terminator to further reduce reflection, as shown in FIG. 6E. The terminator 220 is represented by a dashed-line rectangular box in FIG. 6A. One of ordinary skill in the art would recognize that the terminator 220 may have other shapes, such as circle, oval, square, or other suitable shapes. The terminator 220 absorbs photons escaping from the end of the lower waveguide to suppress interference occurred due to the escaped photons. The terminator 220 may also be added to the embodiments as shown in FIGS. 6C and 6D.

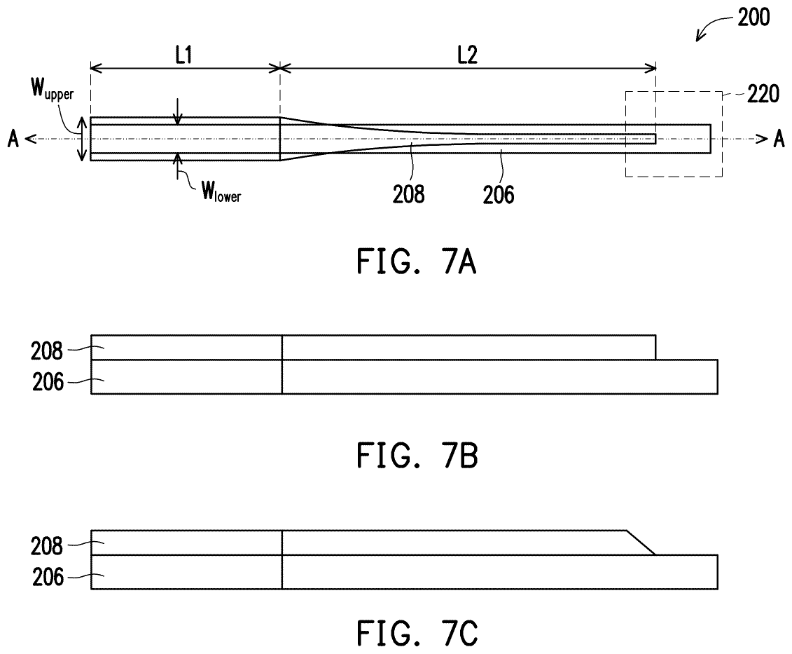

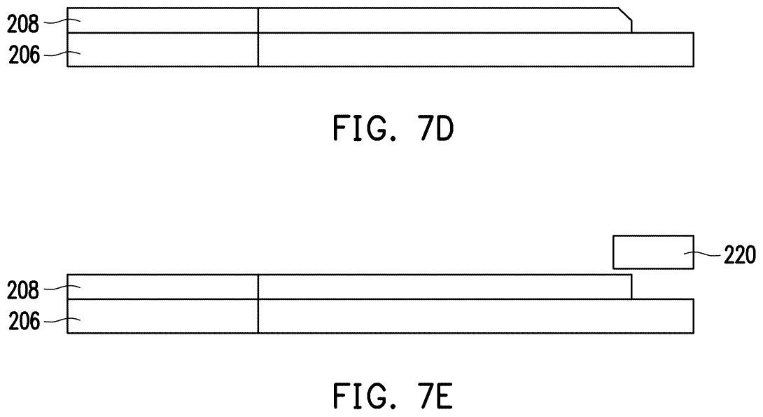

Reference is now made to FIGS. 7A-7E, which illustrate various embodiments of the waveguide portion of the multilayer grating coupler 200, particularly the portion merges light signals traveling in the upper and lower waveguides into the lower waveguide. FIG. 7A is a top view, and FIGS. 7B-7E are cross-sectional views along a cut though the A-A line in FIG. 7A according to various embodiments of the present disclosure.

Since the light signal merges into the lower waveguide in the depicted embodiment, the lower waveguide extends longer than the upper waveguide. The lower wave guide has a constant width W_{lower}. The upper waveguide starts with a first section with a constant width Wᵤₚₚₑᵣ for a length L₁ and gradually shrinks in its second section for a length L₂. The length L₁ may be equal to or less than the length L₂. With the shrinking of the second section, photons in the upper waveguide can be gradually guided toward the lower waveguide. The waveguide with a lower refractive index may be thicker and wider in width, while the waveguide with a higher refractive index may be thinner and narrower in width. In the depicted embodiment, the upper waveguide has a lower refractive index, and consequently the first section of the upper waveguide has the width Wᵤₚₚₑᵣ larger than the width W_{lower} of the lower waveguide, and also thicker. Although not depicted, if the upper waveguide has a higher refractive index, consequently the first section of the upper waveguide has the width Wᵤₚₚₑᵣ smaller than the width W_{lower} of the lower waveguide, and also thinner.

In FIG. 7B, the end of the upper waveguide has a vertical sidewall. As a comparison, in FIG. 7C, the end of the upper waveguide has a slanted sidewall and a vertical sidewall intersecting the lower waveguide, which reduces reflection at the terminal end. Similarly, in FIG. 7D, the end of the upper waveguide has a slanted sidewall intersecting the lower waveguide, which also reduces reflection at the terminal end. In addition, an optical absorbing material 220 may optionally be placed adjacent to the end of the upper waveguide as a terminator to further reduce reflection, as shown in FIG. 7E. The terminator 220 is represented by a dashed-line rectangular box in FIG. 7A. One of ordinary skill in the art would recognize that the terminator 220 may have other shapes, such as circle, oval, square, or other suitable shapes. The terminator 220 absorbs photons escaping from the end of the upper waveguide to suppress interference occurred due to the escaped photons. The terminator 220 may also be added to the embodiments as shown in FIGS. 7C and 7D.

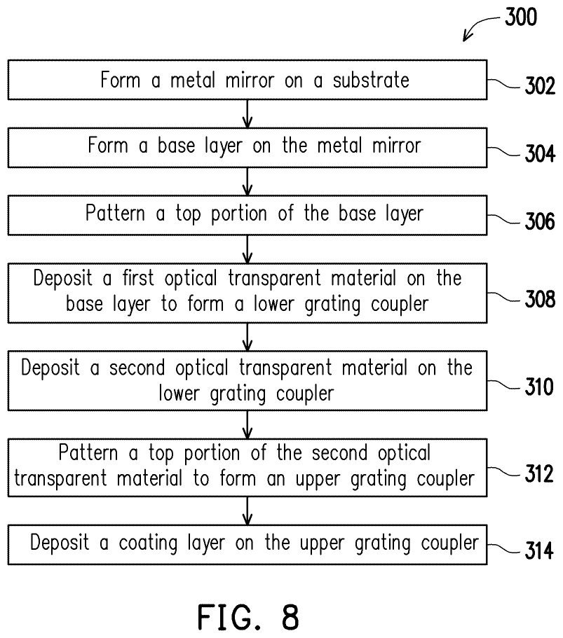

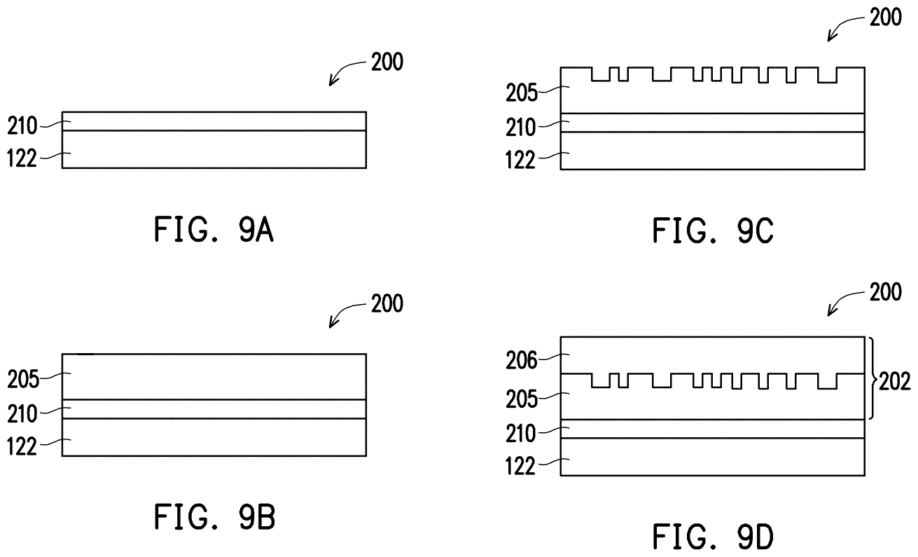

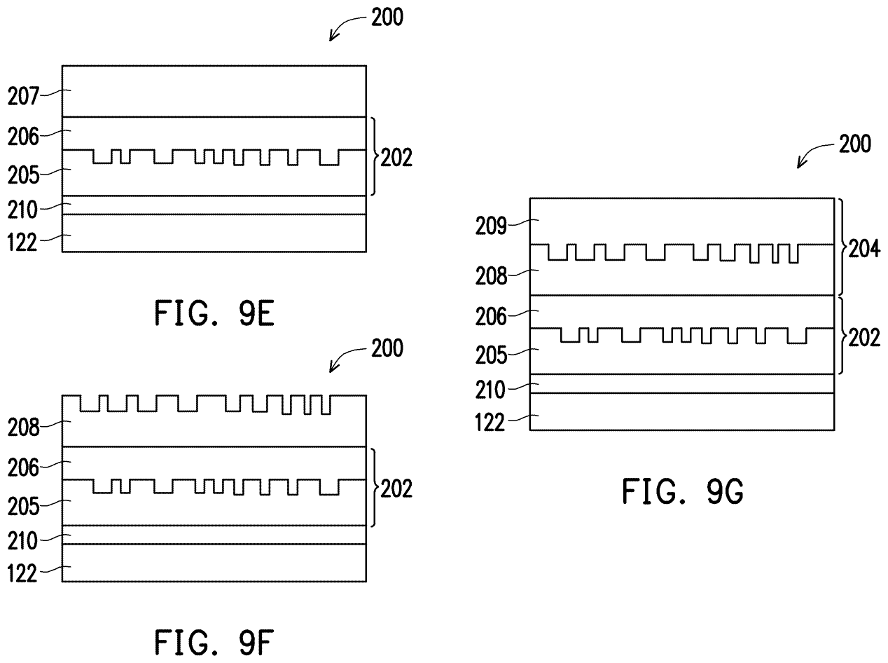

FIG. 8 is a flowchart illustrating a method 300 of forming a multiplayer grating coupler according to embodiments of the present disclosure. Method 300 is merely an example and is not intended to limit the present disclosure to what is explicitly illustrated in method 300. Additional steps can be provided before, during and after method 300, and some steps described can be replaced, eliminated, or moved around for additional embodiments of the method. Not all steps are described herein in detail for reasons of simplicity. Method 300 is described below in conjunction with FIGS. 9A-9G, which are fragmentary cross-sectional views of a workpiece at different stages of fabrication according to embodiments of method 300.

At step 302, a reflective layer 210 is deposited on a substrate 122, as shown in FIG. 9A. The substrate 122 may include an elementary semiconductor including silicon or germanium in crystal, polycrystalline, or an amorphous structure; a compound semiconductor including silicon carbide, gallium arsenic, gallium phosphide, indium phosphide, indium arsenide, and indium antimonide; an alloy semiconductor including SiGe, GaAsP, AlInAs, AlGaAs, GaInAs, GaInP, and GaInAsP; any other suitable material; or combinations thereof. The reflective layer 210 may be a metal layer, such as a copper layer or an aluminum layer. The metal layer may be deposited by a chemical vapor deposition (CVD) process, a physical vapor deposition (PVD) process, an atomic layer deposition (ALD) process, a plating process, or other suitable process. The deposited metal layer is then thinned and planarized, for example by a chemical mechanical polishing (CMP) process, to improve the surface reflection.

At step 304, a base layer 205 is deposited on the reflective layer 210, as shown in FIG. 9B. The base layer 205 may include a dielectric material, such as silicon oxide or other suitable dielectric material. The base layer 205 may be deposited using a CVD process, an ALD process, an oxygen plasma oxidation process, a spin-on coating process, or other suitable processes.

At step 306, the top portion of the base layer 205 is patterned in a lithography process to form trenches which would define the grating features formed later on, as shown in FIG. 9C. The lithography process may include photoresist coating (e.g., spin-on coating), soft baking, mask aligning, exposure, post-exposure baking, photoresist developing, rinsing, drying (e.g., spin-drying and/or hard baking), other suitable lithography techniques, and/or combinations thereof. In some embodiments, the etch process may include dry etching (e.g., RIE etching), wet etching, and/or other etching methods.

At step 308, a first optical transparent material is deposited on the base layer 205 to form a lower grating coupler 206, as shown in FIG. 9D. The optical transparent material may include silicon, silicon nitride, or other suitable optical transparent material. The optical transparent material may be deposited using a CVD process, a PVD process, an ALD process, or other suitable process. The portion of the optical transparent material deposited in the trenches previously defined in the top portion of the base layer 205 forms the grating features of the lower grating coupler 206. The deposited optical transparent material is then thinned and planarized, for example by a CMP process, to a suitable thickness to form a lower waveguide above the base layer 205. The base layer 205 and the lower grating coupler 206 collectively define a lower grating layer 202.

At step 310, a second optical transparent material is deposited on the lower grating coupler 206, denoted as layer 207 as shown in FIG. 9E. The optical transparent material may include silicon, silicon nitride, or other suitable optical transparent material. The optical transparent material may be deposited using a CVD process, a PVD process, an ALD process, or other suitable process. In one example, the first and second optical transparent materials include the same optical transparent material, such as silicon nitride, and there is no obvious boundary between the two optical transparent materials. In another example, the first and second optical transparent materials include different optical transparent materials, such as one made of silicon and another made of silicon nitride, and there is a visible boundary between the first and second optical transparent materials. The deposited second optical transparent material may be thinned and planarized, for example by a CMP process, to a suitable thickness to form an upper waveguide above the lower grating coupler 206.

At step 312, the second optical transparent material is patterned in a lithography process to form an upper grating coupler 208 with grating features, as shown in FIG. 9F. The lithography process may include photoresist coating (e.g., spin-on coating), soft baking, mask aligning, exposure, post-exposure baking, photoresist developing, rinsing, drying (e.g., spin-drying and/or hard baking), other suitable lithography techniques, and/or combinations thereof. In some embodiments, the etch process may include dry etching (e.g., RIE etching), wet etching, and/or other etching methods.

At step 314, a coating layer 209 is deposited on the upper grating coupler 208, as shown in FIG. 9G. The coating layer 209 may include a dielectric material, such as silicon oxide or other suitable dielectric material. The coating layer 209 may be deposited using a CVD process, an ALD process, an oxygen plasma oxidation process, a spin-on coating process, or other suitable processes. The upper grating coupler 208 and the coating layer 209 collectively define an upper grating layer 204.

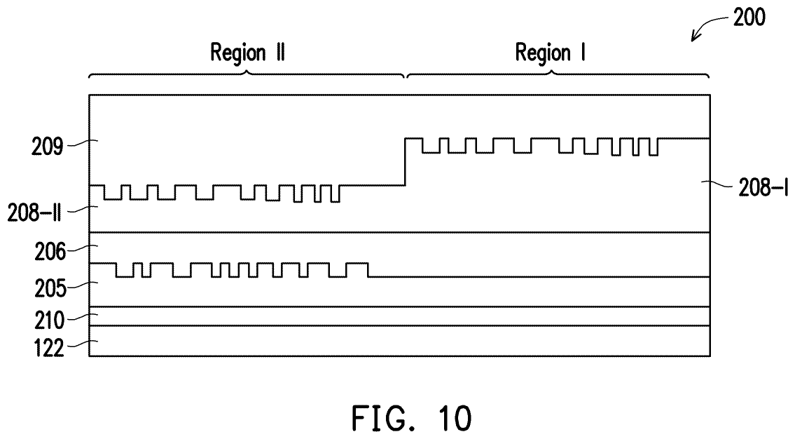

In some alternative embodiments, the lithography process performed at step 312 may include multiple etching processes performed at multiple regions of the second optical transparent material to form a stack of two or more grating couplers from a single second optical transparent material. An exemplary resultant structure is illustrated in FIG. 10, which includes an upper grating coupler 208-I formed in a region I of the second optical transparent material and a middle grating coupler 208-II formed in a region II of the second optical transparent material. The lower grating coupler 206 is stacked underneath the middle grating coupler 208-II and the upper grating coupler 208-I. In one exemplary lithography process performed at step 312, a first etching process is performed to recess the second optical transparent material in the region II, while the region I is protected under a mask layer; subsequently, a second etching process is performed to form the grating features in the region I to form the upper grating coupler 208-I, while the region II is protected under a mask layer; then, a third etching process is performed to form the grating features in the region II to form the middle grating coupler 208-II, while the region I is protected under a mask layer; at the conclusion of step 312, the mask layer is removed to expose the whole patterned second optical transparent material and for the coating layer 209 to deposited thereon at subsequent step 314. Similar to the discussion above, the geometric dimensions of the grating features in each of the three grating couplers 208-1, 208-II, and 206 may be independently defined to suit various application needs.

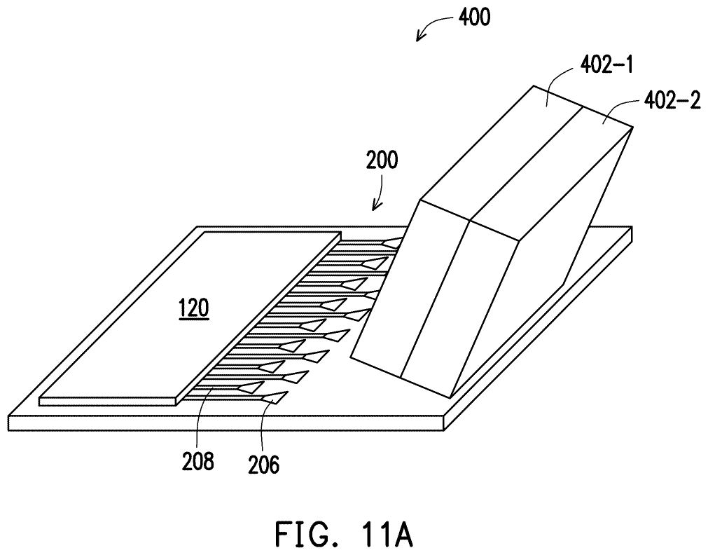

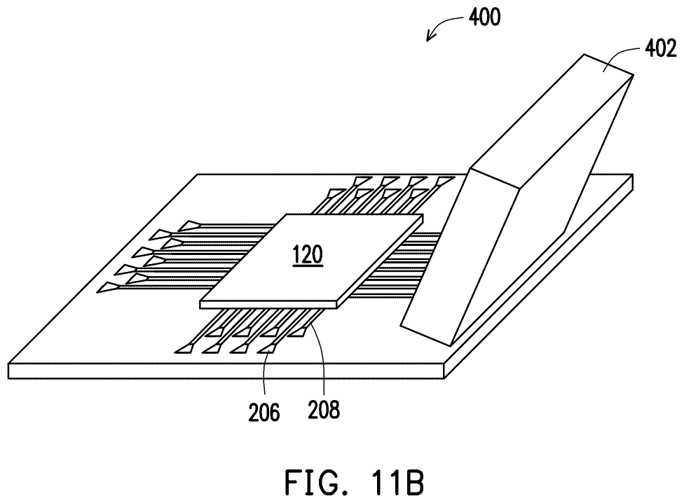

For a semiconductor chip with a large number of optical I/O ports, the proposed multilayer grating coupler architecture can be used to consolidate I/O ports to one or more edges of the semiconductor chip, reducing the area and complexity of I/O ports, while improving system reliability and performance. In addition, for measurement or packaging, a large number of fibers may be consolidated into a fiber bus or fiber array that can be configured for transmission at the same time, improving stability and locality. FIGS. 11A and 11B illustrate perspective views of a fiber-to-chip coupling system 400 in accordance with some embodiments. The fiber-to-chip coupling system 400 includes the chip 120 and the multilayer grating coupler 200. In FIG. 11A, the multilayer grating coupler 200 includes a row of lower grating couplers 206 and a row of upper grating couplers 208. Each of the lower grating couplers 206 and the upper grating couplers 208 may function independently, for example, based on the topology in FIGS. 5A-5C. A first fiber bus 402-1 that includes a cluster of fibers lined up is coupled to the upper grating couplers 208, and a second fiber bus 402-2 that includes a cluster of fibers line up is coupled to the lower grating couplers 208. In FIG. 11B, the multilayer grating coupler 200 includes a row of lower grating couplers 206 and a row of upper grating couplers 208. Each of the lower grating couplers 206 and a corresponding one of the upper grating couplers 208 form a pair, for example, based on the topology in FIGS. 3A-3C or the topology in FIGS. 4A-4C. A fiber bus 402 that includes a cluster of fibers lined up is coupled to the upper grating couplers 208 and the lower grating couplers 206 collectively. That is, each fiber in the fiber bus 402 feeds a lower grating coupler 206 and a corresponding upper grating coupler 208 in the same pair simultaneously.

Although not intended to be limiting, embodiments of the present disclosure provide one or more of the following advantages. For example, embodiments of the present disclosure form an optical coupling apparatus based on a multilayer structure. The multilayer structure allows for grating couplers in different layers to have their own grating dimensions, which can guide an incident light to the optimal position and reduce energy loss, resulting in improved coupling efficiency. The multilayer structure can achieve a wider bandwidth due to the use of different grating structures in each layer, which can adjust the spacing and angle to guide the incident light corresponding to different wavelengths. By positioning the grading features in different layers, the multilayer structure can reduce interference and attenuation, resulting in improved stability. Further, embodiments of the present disclosure can be readily integrated into existing semiconductor manufacturing processes.

In one example aspect, the present disclosure provides an apparatus for optical coupling. The apparatus includes a substrate, a reflecting layer disposed on the substrate, a lower grating layer above the reflecting layer, the lower grating layer including a base layer and a lower grating coupler above the base layer, and an upper grating layer above the lower grating layer, the upper grating layer including an upper grating coupler and a coating layer above the upper grating coupler. In a top view of the apparatus, a centerline of the lower grating coupler aligns with a centerline of the upper grating coupler. In some embodiments, the lower grating coupler includes a lower grating section and a lower waveguide section, the upper grating coupler includes an upper grating section and an upper waveguide section, and the lower grating section overlaps with the upper grating section in the top view. In some embodiments, the lower grating section and the upper grating section are substantially identical. In some embodiments, the lower grating section and the upper grating section have different geometric dimensions. In some embodiments, the lower grating coupler includes a lower grating section and a lower waveguide section, the upper grating coupler includes an upper grating section and an upper waveguide section, and the lower grating section has no overlap with the upper grating section in the top view. In some embodiments, the lower waveguide section overlaps with the upper grating section in the top view. In some embodiments, the lower grating section and the upper grating section are substantially identical. In some embodiments, the lower grating section and the upper grating section have different geometric dimensions. In some embodiments, the lower grating coupler is in physical contact with the upper grating coupler. In some embodiments, the lower grating coupler and the upper grating coupler include different optical transparent materials.

Another aspect of the present disclosure provides an apparatus for optical coupling. The apparatus includes a substrate, a reflecting layer disposed on the substrate, a lower grating layer above the reflecting layer, the lower grating layer including a lower grating coupler formed therein, and an upper grating layer above the lower grating layer, the upper grating layer including an upper grating coupler formed therein. The lower grating coupler includes a lower waveguide, the upper grating coupler includes an upper waveguide, and the lower and upper waveguides are configured to merge light photons traveling therein into one of the lower and upper waveguides. In some embodiments, in a top view of the apparatus the lower and upper waveguides overlap. In some embodiments, one of the lower and upper waveguides has a constant width section and a tapering width section. In some embodiments, the constant width section is shorter than the tapering width section. In some embodiments, one of the lower and upper waveguides is shorter than another and includes a slanted terminal sidewall. In some embodiments, the apparatus further includes an optical absorbing material overlapping with a terminal end of one of the lower and upper waveguides in a top view of the apparatus.

Yet another aspect of the present disclosure provides a method for fabricating an optical apparatus. The method includes forming a reflective layer on a substrate, depositing a base layer on the reflective layer, patterning a top portion of the base layer to form a plurality of first trenches, depositing a first optical transparent material on the base layer, the first optical transparent material filling the first trenches in forming a plurality of first grating teeth of a first grating coupler, depositing a second optical transparent material on the first optical transparent material, patterning a top portion of the second optical transparent material to form a plurality of second grating teeth of a second grating coupler, and depositing a coating layer on the second optical transparent material. The coating layer fills a plurality of second trenches defined between adjacent ones of the second grating teeth. In some embodiments, the method further includes thinning the first optical transparent material to form a first waveguide. In some embodiments, the method further includes prior to the patterning of the top portion of the second optical transparent material, thinning the second optical transparent material to form a second waveguide. In some embodiments, the first optical transparent material is different from the second optical transparent material.

The foregoing has outlined features of several embodiments. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. An apparatus for optical coupling, comprising:
a semiconductor substrate;
a reflective layer disposed on the semiconductor substrate;
a lower grating layer above the reflective layer, the lower grating layer including a base layer and a lower grating coupler above the base layer, grating teeth of the lower grating coupler facing the semiconductor substrate; and
an upper grating layer above the lower grating layer, the upper grating layer including an upper grating coupler and a coating layer above the upper grating coupler, grating teeth of the upper grating layer facing away from the semiconductor substrate.

2. The apparatus of claim 1, wherein, when viewed from top, a centerline of the lower grating coupler is parallel with but offset from a centerline of the upper grating coupler.

3. The apparatus of claim 1, wherein, when viewed from top, a centerline of the lower grating coupler aligns with a centerline of the upper grating coupler.

4. The apparatus of claim 3, wherein the lower grating coupler includes a lower grating section and a lower waveguide section, the upper grating coupler includes an upper grating section and an upper waveguide section, and the lower grating section overlaps with the upper grating section when viewed from top.

5. The apparatus of claim 3, wherein the lower grating coupler includes a lower grating section and a lower waveguide section, the upper grating coupler includes an upper grating section and an upper waveguide section, and the lower grating section is free of overlapping with the upper grating section when viewed from top.

6. The apparatus of claim 1, wherein the grating teeth of the lower grating coupler fully align with the grating teeth of the upper grating coupler.

7. The apparatus of claim 1, wherein the grating teeth of the lower grating coupler partially align with the grating teeth of the upper grating coupler.

8. The apparatus of claim 1, wherein no grating teeth of the lower grating coupler aligns with any of the grating teeth of the upper grating coupler.

9. The apparatus of claim 1, wherein the grating teeth of one of the lower grating coupler or the upper grating coupler has a uniform depth.

10. The apparatus of claim 1, wherein the grating teeth of one of the lower grating coupler or the upper grating coupler has a non-uniform depth.

11. An apparatus for optical coupling, comprising:
a semiconductor substrate;
a reflective layer disposed on the semiconductor substrate;
a lower grating layer above the reflective layer, the lower grating layer including a lower grating coupler having a lower grating section and a lower waveguide; and
an upper grating layer above the lower grating layer, the upper grating layer including an upper grating coupler having an upper grating section and an upper waveguide,
wherein the lower and upper waveguides are configured to merge light photons traveling therein into one of the lower and upper waveguides.

12. The apparatus of claim 11, wherein the lower waveguide is configured to merge the light photons traveling therein into the upper waveguide.

13. The apparatus of claim 11, wherein the upper waveguide is configured to merge the light photons traveling therein into the lower waveguide.

14. The apparatus of claim 11, wherein, when viewed from top, the lower and upper waveguides overlap.

15. The apparatus of claim 11, wherein one of the lower and upper waveguides has a first constant width section and a tapering width section abutting the first constant width section.

16. The apparatus of claim 15, wherein another one of the lower and upper waveguides has a second constant width section overlapping with the tapering width section when viewed from top.

17. A method for fabricating an optical apparatus, comprising:
forming a reflective layer on a semiconductor substrate;
depositing a first dielectric layer on the reflective layer;
patterning a top portion of the first dielectric layer to form a plurality of first trenches;
depositing a first optical transparent material on the first dielectric layer, wherein the first optical transparent material fills the first trenches in forming a plurality of first grating teeth of a first grating coupler;
depositing a second optical transparent material on the first optical transparent material;
patterning a top portion of the second optical transparent material to form a plurality of second grating teeth of a second grating coupler; and
depositing a second dielectric layer on the second optical transparent material, wherein the second dielectric layer fills a plurality of second trenches defined between adjacent ones of the second grating teeth.

18. The method of claim 17, further comprising:
thinning the first optical transparent material to form a first waveguide.

19. The method of claim 18, further comprising:
thinning the second optical transparent material to form a second waveguide, wherein when viewed from top the first waveguide overlaps with the second waveguide.

20. The method of claim 17, wherein the first optical transparent material is different from the second optical transparent material.
